(19) United States
(12) Patent Application Publication
(10) Pub. No.: US 2009/0220699 A1
(43) Pub. Date: Sep. 3, 2009

(54) METHOD FOR MANUFACTURING CERAMIC HONEYCOMB STRUCTURE AND COATING MATERIAL USED FOR THE METHOD

(75) Inventors: Ryuta KONO, Nagoya-city (JP); Yoshiro ONO, Nagoya-city (JP); Yasushi NOGUCHI, Nagoya-city (JP)

Correspondence Address: OLIFF & BERRIDGE, PLC, P.O. BOX 320850, ALEXANDRIA, VA, 22320-4850, US

(73) Assignee: NGK INSULATORS, LTD., Nagoya-City (JP)

(21) Appl. No.: 12/389,166

(22) Filed: Feb. 19, 2009

(30) Foreign Application Priority Data
Feb. 28, 2008 (JP) 2008-047821

(51) Int. Cl. B05D 3/02; C09D 1/00

(52) U.S. Cl. 427/384; 106/287.26

(57) ABSTRACT

A method for manufacturing a ceramic honeycomb structure includes the steps of: forming the outer periphery of a ceramic structure having a plurality of cells separated by ceramic porous partition walls into a predetermined shape; applying a coating material containing at least a ceramic powder, water, and a high-boiling additive having a higher boiling point than that of water on an outer periphery of the cell structure 2 so as to cover the outer periphery; and drying the coating material by heating to form an outer wall 3. The method provides a method for manufacturing a honeycomb structure having the outer wall formed by covering the outer periphery with a coating material and hardly having a crack and a defect such as peeling and a coating material.

### BACKGROUND OF THE INVENTION AND RELATED ART STATEMENT

The present invention relates to a method for manufacturing ceramic honeycomb structure regarding the formation of the outer wall of the ceramic honeycomb structure and a coating material used for the method.

There is used a honeycomb structure made of thermal resistant ceramic as a carrier for loading a catalyst purifying nitrogen oxide (NOₓ) or carbon monoxide (CO) in exhaust gas from an automobile or as a filter for trapping particulate matter in exhaust gas. A ceramic honeycomb structure has low mechanical strength because of thin partition walls and high porosity. In order to compensate the strength and to inhibit breakage, slurry (hereinbelow referred to as a “coating material”) containing a ceramic powder is applied, dried, and fired on the outer periphery of a honeycomb structure (cell structure) having a given diameter formed by grinding to form an outer wall (see, e.g., JP-A-5-269388 and Japanese Patent No. 2604876).

When a coating material is applied and dried on the outer periphery of the honeycomb structure, a crack is generated due to a difference in shrinkage between the surface and the inside of the coating material. Since the crack in the outer wall could cause decrease in strength of the ceramic honeycomb structure and leakage of a catalyst solution from the crack in the case that a catalyst is loaded on the outer wall, the crack is manually mended.

WO2004/063125 disclosed a coating material hardly causing a crack in the outer wall by suppressing the difference in shrinkage by the use of a coarser ceramic powder.

However, since a coating material hardly causing a crack of the WO2004/063125 employs a coarse powder, it is difficult to employ the coating material because of different hand feeling and the like in comparison with a conventional coating material. Therefore, when drying is performed at 100° C. for one hour after applying a coating material with employing a coating material conventionally used, a crack is generated in the outer wall. When the coating material is dried at ordinary temperature (25° C., 50% RH (relative humidity)), it takes 24 hours or more for the coating material to dry. Therefore, the present situation is that a method hardly causing a crack and capable of easily forming an outer wall without a problem of hand feeling, appearance, or the like is not present.

### SUMMARY OF THE INVENTION

The present invention aims to provide a method for manufacturing a honeycomb structure, where an outer wall hardly having a crack and a defect such as peeling is formed by covering the outer periphery with a coating material, and a coating material.

The present inventors presumed that a crack in the outer wall is influenced by drying shrinkage of a coating material and that a crack generates mainly because a current coating material has a large drying shrinkage rate upon drying by heating, and they found that, in order to lower the drying shrinkage rate upon drying by heating, a high-boiling additive having a higher boiling point than that of water is added to a coating material, and thereby a dispersion medium is left even after water is evaporated to suppress drying shrinkage, followed by evaporating the residual additive at higher temperature. That is, according to the present invention, there is provided the following method for manufacturing a honeycomb structure.

[1] A method for manufacturing a ceramic honeycomb structure, the method comprising the steps of: preparing a coating material containing at least a ceramic powder, water, and a high-boiling additive having a higher boiling point than that of water; applying the coating material on outer periphery of a cell structure having a plurality of cells separated by ceramic porous partition walls so as to cover the outer periphery; and

drying the coating material by heating to form an outer wall.

[2] The method for manufacturing a ceramic honeycomb structure according to the above [1], wherein a first drying is performed in a temperature rage from the boiling point of water to the boiling point of the high-boiling additive, followed by a second drying performed at a temperature of the boiling point of the high-boiling additive or higher.

[3] The method for manufacturing a ceramic honeycomb structure according to the above [1] or [2], wherein the high-boiling additive is a water-soluble substance.

[4] The method for manufacturing a ceramic honeycomb structure according to any one of the above [1] to [3], where in the high-boiling additive is at least one kind selected from the group consisting of glycerin, propylene glycol, dipropylene glycol, butylene glycol, diethylene glycol, polyethylene glycol, and 1,5-pentanediol.

[5] The method for manufacturing a ceramic honeycomb structure according to any one of the above [1] to [4], wherein the coating material contains 2 to 10% glycerin as the high-boiling additive.

[6] The method for manufacturing a ceramic honeycomb structure according to any one of the above [1] to [4], wherein the coating material contains 2 to 6% dipropylene glycol as the high-boiling additive.

[7] The method for manufacturing a ceramic honeycomb structure according to the above [5] or [6], wherein, after the coating material is applied, the first drying is performed in a temperature range from 100 to 200° C., followed by the second drying performed in a temperature range from of 300 to 400° C.

[8] A coating material used for a method for manufacturing a ceramic honeycomb structure according to any one of the above [1] to [7] and containing at least a ceramic powder, water, and a high-boiling additive having a higher boiling point than that of water.

An outer wall is formed by applying, on the outer periphery of the ceramic honeycomb structure, a coating material containing a high-boiling additive having a higher boiling point than that of water to be able to suppress crack generation in the outer wall.

### BRIEF DESCRIPTION OF THE DRAWINGS

FIG. 1A is a cross-sectional view cut along a plane perpendicular to the central axis of a honeycomb structure.

FIG. 1B is a perspective view showing a honeycomb structure.

FIG. 2A is a perspective view showing a honeycomb segment.

FIG. 2B is a perspective view showing a honeycomb structure formed by bonding honeycomb segments.

FIG. 3 is a view for describing measurement for a drying shrinkage rate.

FIG. 4 is a view for describing a method for cutting a sample.

FIG. 5 is a view for describing manufacture of a sample for crack observation.

FIG. 6 is a photograph for describing crack observation.

### REFERENCE NUMERALS

1: honeycomb structure, 1a: plate-shaped object, 2: cell structure, 3: outer wall, 4: cell, 5: partition wall, 7: coating material, 10: honeycomb structure, 12: cell structure, 14: cell, 15: partition wall, 17: outer peripheral wall, 18: bonding layer, 22: honeycomb segment, 31: metal petri dish, 32: mold, 33: squeegee

### DETAILED DESCRIPTION OF THE INVENTION

Hereinbelow, embodiments of the present invention will be described with referring to drawings. The present invention is not limited to the following embodiments, and changes, modifications, improvements may be added thereto as long as they do not deviate from the scope of the present invention.

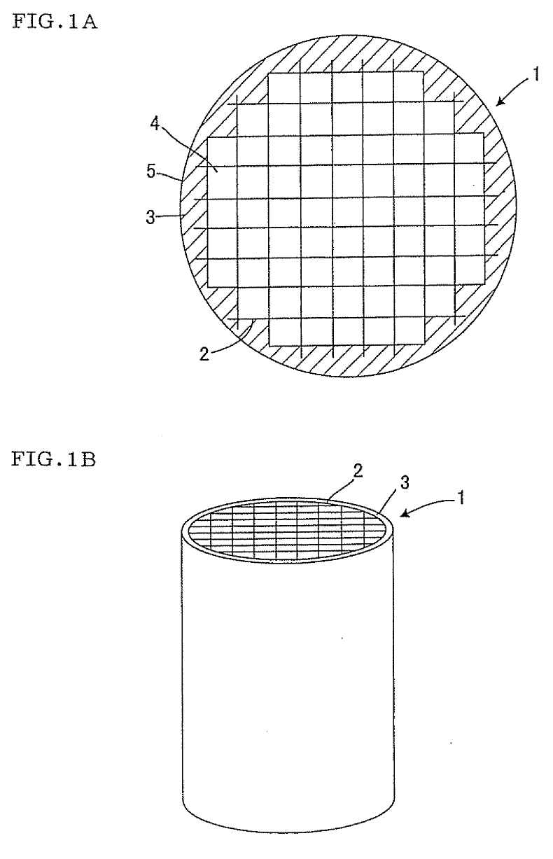

As shown in FIGS. 1A and 1B, a honeycomb structure 1 manufactured by a manufacturing method of the present invention is provided with a honeycomb-shaped cell structure 2 of a porous body having a large number of pores and a plurality of cells 4 functioning as fluid passages by being separated by very thin partition walls 5 and an outer wall 3 formed so as to cover the outer periphery of the cell structure 2.

A method for manufacturing a ceramic honeycomb structure of the present invention is a method where the outer periphery of a cell structure 2 having a plurality of cells 4 separated by ceramic porous partition walls 5 is formed to have a predetermined shape; a coating material containing at least a ceramic powder, water, and a high-boiling additive having a higher boiling point than that of water is applied on the outer periphery to cover the outer periphery; and the coating material is dried by heating to form an outer wall 3.

In addition, after the coating material is applied, the first drying is performed in a temperature range from the boiling point of water to the boiling point of the high-boiling additive, and then the second drying is performed at a temperature of a boiling point of the high-boiling additive or higher. That is, a liquid substance having a higher boiling point than that of water is added to the coating material, and stage drying of (1) evaporation of water at 100° C. and then (2) evaporation of additive at a temperature higher than 100° C. to manufacture an outer wall with no crack generated therein. That is, since rapid drying shrinkage can be inhibited by performing such stage drying, crack generation in the outer wall can be inhibited.

The coating material contains at least a ceramic powder, water, and a high-boiling additive having a higher boiling point than that of water and applied in a slurried state. As the ceramic powder, there can be used a material similar to the materials used for a honeycomb structure 1 or a honeycomb segment 22 described below. The coating material may contain a bonding material such as colloidal silica, ceramic fibers, an inorganic additive, an organic additive, a foaming particle, a surfactant, and the like.

As the high-boiling additive having a higher boiling point than that of water, a substance having low toxicity is preferable because the additive cannot be allowed to remain in a product and has to be evaporated finally. In addition, since the additive is used together with water, which is a dispersion medium, the additive is preferably a water-soluble substance.

As the high-boiling additive, specifically, at least one kind selected from the group consisting of glycerin, propylene glycol, dipropylene glycol, butylene glycol, diethylene glycol, polyethylene glycol, and 1,5-pentanediol can be used.

Further, when glycerin is used as the high-boiling additive contained in the coating material, the glycerin is preferably contained at a rate of 2 to 10%. By the glycerin contained in this range, a crack can effectively be reduced. In order to completely prohibit crack generation, glycerin is preferably contained at a rate of 4 to 10%. When the rate is below 2%, rapid drying shrinkage is easily caused upon evaporation of water. When the rate is above 10%, rapid drying shrinkage is easily caused upon evaporation of glycerin, a crack easily generates. In addition, when glycerin is used, it is preferable that the first drying is performed in a temperature range from 100 to 200° C., followed by the second drying in a temperature range from 300 to 400° C. It is more preferable to perform the first drying at 100° C. and the second drying at 300° C. Water is evaporated at 100° C., and glycerin can be evaporated at 300° C. since the boiling point of glycerin is 290° C. In addition, when dipropylene glycol is used, it is preferably contained at a rate of 2 to 6%, and drying can be performed similarly.

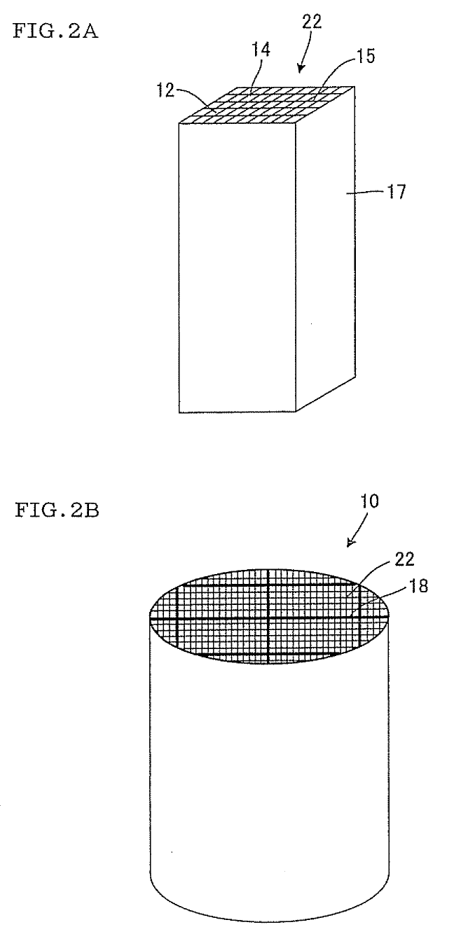

A ceramic honeycomb structure capable of applying a manufacturing method of the present invention may be a honeycomb structure 10 where a plurality of honeycomb segments 22 are unitarily bonded with a bonding material as shown in FIGS. 2A and 2B besides an integral honeycomb structure 1 described by using FIGS. 1A and 1B. The honey combstructure 10 is unitarily formed by bonding a plurality of honeycomb segments 22 each provided with a cell structure 12 having a plurality of cells 14 separated by porous partition walls 15 and functioning as fluid passages and porous outer peripheral walls 17 disposed in the outer periphery of the cell structure 12 with a bonding material at the outer peripheral walls 17. The bonding material is dried to form a bonding layer 18 on the outer peripheral wall 17, and the outer peripheral walls 17 are bonded together by means of the bonding layer 18.

As a material for the honeycomb structure 1 or the honeycomb segment 22, there can be used a material selected from the group consisting of cordierite, mullite, alumina, spinel, silicon carbide, metal silicon, silicon-silicon carbide based composite materials, silicon carbide-cordierite based composite materials, silicon nitride, lithium aluminum silicate, and Fe—Cr—Al based metals; or a combination thereof.

Next, a method for manufacturing a ceramic honeycomb structure of the present invention will be described. In the present invention, the cell structure 2 can be obtained by subjecting kneaded clay of predetermined raw materials to extrusion forming or the like to obtain a honeycomb-shaped formed body, and then drying and firing the formed body. The outer shape, dimensions, cell shape, cell density, partition wall thickness, and the like are not particularly limited and can suitably be selected according to the use and the environment of usage.

In order to obtain a honeycomb structure 1 shown in FIG. 1B, in the first place, forming raw materials are formed into kneaded clay. Next, by forming the clay, there can be obtained the cell structure 2 also as an integral formed body including partition walls forming a plurality of cells partitioned into a honeycomb shape. Though there is no particular limitation on a forming technique, extrusion forming is generally preferable, and it is preferable to use a plunger type extruder, a biaxial screw type continuous extruder, or the like.

Alternatively, honeycomb segments 22 as shown in, for example, FIG. 2A are formed. The honeycomb segments 22 are unitarily bonded by means of bonding layers 18 to obtain a cell structure 12. Incidentally, the bonding material used for forming the bonding layers 18 is constituted so as to contain inorganic particles and an inorganic adhesive as the main components and an organic binder, a surfactant, a foaming resin, water, and the like as accessory components.

Then, a part of the outer periphery of the cell structure 2 integrally formed or the cell structure 12 formed by unitarily bonding the honeycomb segments 22 is removed. As a technique for processing the outer peripheral portion of the cell structures 2 and 12 into a predetermined shape, grinding is general. However, another processing technique may be employed.

Then, the aforementioned coating material containing at least a ceramic powder, water, and a high-boiling additive having a higher boiling point than that of water is applied on a surface exposed to the outer periphery of the partition walls located in the outermost periphery, followed by drying and firing to manufacture honeycomb structures 1 and 10 where the outer periphery is covered with the coating material. Drying should be stage drying as described above. That is, the first drying is performed in a temperature range from the boiling point of water to the boiling point of the high-boiling additive, followed by a second drying performed at a temperature of the boiling point of the high-boiling additive or higher. In this manner, crack generation in the outer wall can be inhibited.

Incidentally, the honeycomb structures 1 and 10 may have plugging portions disposed so as to alternately plug one of the end portions of each cell in the two end faces.

Hereinbelow, the present invention will be described in more detail on the basis of Examples. However, the present invention is by no means limited to these Examples.

(Preparation of Coating Material)

A coating material was prepared using a powder of potsherd, ceramic fibers, an inorganic additive, an organic additive as a framework, water as a dispersion medium, colloidal silica as a bonding material glycerin and dipropylene glycol as a crack inhibitor (high-boiling additive). Incidentally, in order to stabilize coatability of the coating material, 0 to 4% of water was further added, and the viscosity was adjusted to 220±30 dpa·s to control the amount of water to be about 100% in total. The mixing ratios of the coating materials are shown in Table 1.

(Measurement for Drying Shrinkage Rate)

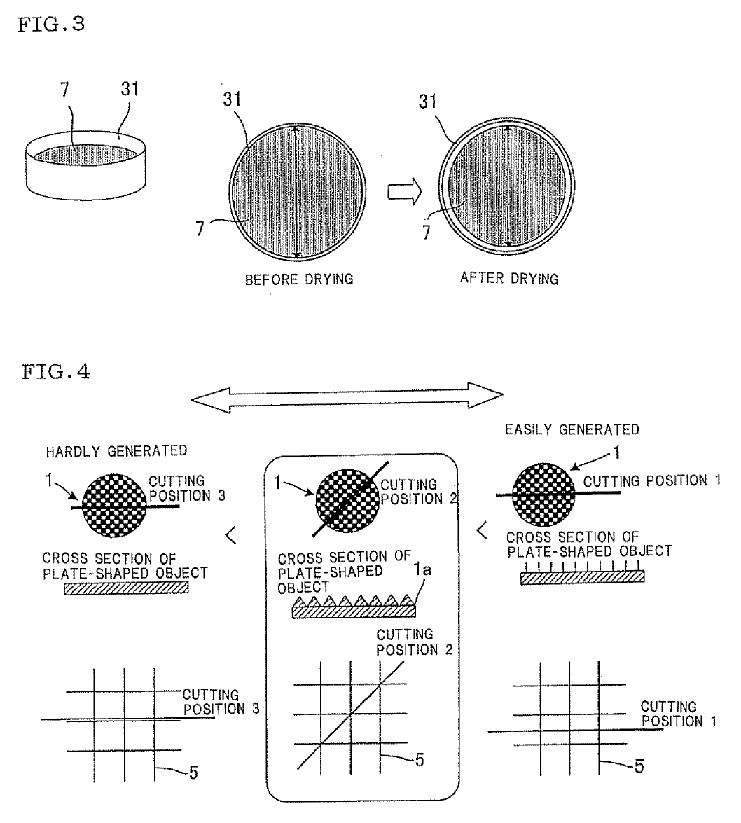

As shown in FIG. 3, coating materials 7 (Example 1 to 23 and Comparative Example 1 to 2) prepared above were cast in a predetermined metal petri dish 31 to perform drying in the controlled environment at a temperature of 25° C. and a humidity of 50% RH. Diameters before and after drying were measured by a vernier caliper to obtain drying shrinkage rates.

(Crack Observation)

As shown in FIG. 4, a plate-shaped object 1a obtained by cutting a cordierite ceramic honeycomb structure 1 having a porosity of 48% in 45° direction with respect to the cells 4 was used for the test because a test in which an outer wall is actually formed takes much time. Even with a plate-shaped object 1a, an effect similar to that in a case of applying the coating material on the outer wall can be obtained. There was used for the test a plate-shaped object 1a obtained by cutting the structure in 45° direction with respect to the partition walls 5 of the cells 4 shown in the cutting position 2 of FIG. 4. The reason why it was cut in an oblique direction with respect to the partition walls 5 is that the test is performed in the conditions where cracks tend to generate more easily (the condition having large unevenness in the face for application) However, in the conditions where cracks tend to generate most easily (cutting position 1), the unevenness is brittle and it is difficult to uniformalize height when the plate-shaped object 1a is manufactured. Therefore, the plate-shaped object obtained by cutting in an oblique direction (cutting position 2) with respect to the partition walls 5 was used for the test (Incidentally, in the cutting position 3, cracks are hardly generated).

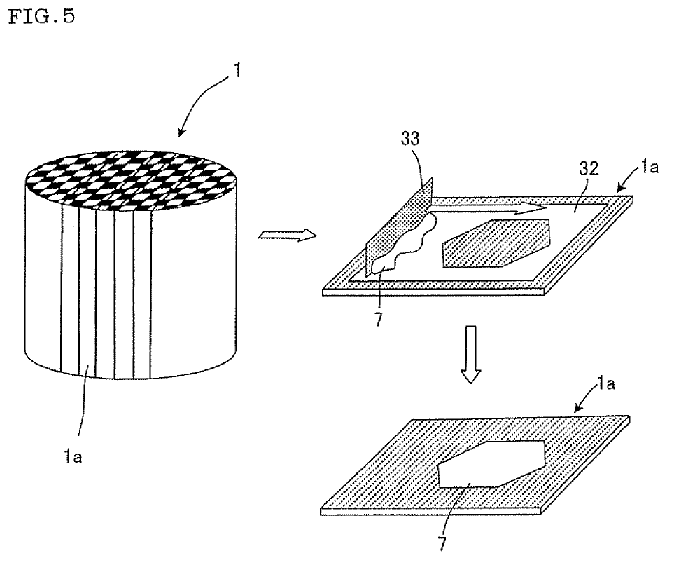

The plate-shaped object 1a was cut out from the honeycomb structure 1 as shown in FIG. 5. By using a predetermined mold 32, and a squeegee 33 was moved on the mold 32 to apply the coating material 7 (Examples 1 to 23 and Comparative Examples 1 to 2) on the object 1a, followed by drying at 100° C. for one hour to harden the coating material 7.

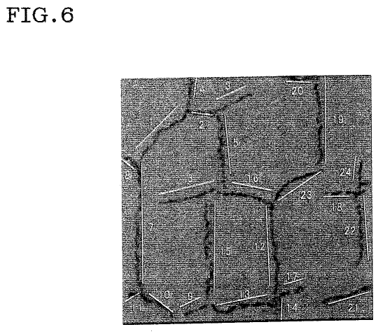

A natural convection type dryer was used for drying by heating. Incidentally, it is necessary to change drying temperature and time depending on the water ratio and the kind (boiling point) and the amount of the additive. From the change in the weight, in the case of the water ratio of 8.7% and the amount of glycerin of 6% as carried out this time, absolute dry can be obtained by drying at 100° C. for one hour and then at 300° C. for 20 minutes. Therefore, the temperature and the time were employed for drying. Then, crack generation which can be observed visually was confirmed, and the evaluation was given by counting the number of cracks with defining a crack from a branch point to another branch point as one crack as shown in FIG. 6.

Further, regarding each of Examples 7 to 9 among those having no crack with applying the coating material 7 on the plate-shaped object 1a, the coating material 7 was applied on the outer periphery of the ceramic honeycomb structure, and crack generation was confirmed again. That is, after the coating material was applied so as to cover the outer periphery of the ceramic honeycomb structure by using a predetermined outer periphery coater, the coating material was hardened by drying at 100° C. for one hour and continuously drying at 300° C. for 20 minutes to manufacture a ceramic honeycomb structure having an outer diameter of 160 mm, a height of 150 mm, and a coat thickness of 1 mm. Cracks caused in the outer wall were observed visually. The results are shown in Table 1.

TABLE 1

| | Drying | Drying | |
|---|---|---|---|
| | shrinkage rate | shrinkage rate | |
| | (%) | (%) | |
| Coating material | 100° C. drying | 300° C. drying | Number of cracks |
| Comp. Ex. 1 | 0.96 | 0.92 | 115 |
| Example 1 | 0.81 | 0.66 | 4 |
| Example 2 | 0.89 | 0.85 | 11 |
| Example 3 | 0.89 | 0.96 | 9 |
| Example 4 | 0.72 | 0.72 | 8 |
| Example 5 | 0.90 | 0.87 | 13 |
| Example 6 | 0.85 | 0.79 | 7 |
| Example 7 | 0.89 | 0.57 | 0 |
| Example 8 | 0.63 | 0.55 | 0 |
| Example 9 | 0.52 | 0.60 | 0 |
| Example 10 | 0.45 | 0.51 | 0 |
| Example 11 | 0.46 | 0.59 | 0 |
| Example 12 | 0.53 | 0.63 | 0 |
| Example 13 | 0.60 | 0.83 | 0 |
| Example 14 | 0.58 | 0.79 | 0 |
| Example 15 | 0.49 | 0.76 | 0 |
| Example 16 | 0.26 | 0.79 | 0 |
| Example 17 | 0.29 | 0.61 | 0 |
| Example 18 | 0.33 | 0.69 | 0 |
| Example 19 | 0.37 | 0.86 | 0 |
| Example 20 | 0.40 | 0.84 | 0 |
| Example 21 | 0.33 | 0.76 | 0 |
| Example 22 | 0.46 | 0.71 | 0 |
| Example 23 | 0.43 | 0.71 | 0 |
| Comp. Ex. 2 | 0.29 | 0.99 | 79 |

| | Mixing ratio (mass %) | | | | | | | | | |
|---|---|---|---|---|---|---|---|---|---|---|
| | | Ceramic | Inorganic | Organic | | Colloidal | Resin | | Dipropylene | |
| Coating material | Potsherd | fiber | additive | additive | Water | silica | balloon | glycerin | glycol | Surfactant |
| Comp. Ex. 1 | 60.1 | 3 | 0.6 | 0.1 | 14.7 | 18 | 0 | 0 | 0 | 0 |
| Example 1 | 60.1 | 3 | 0.4 | 0.1 | 13.9 | 16 | 0.1 | 2 | 0 | 0.1 |
| Example 2 | 60.1 | 3 | 0.8 | 0.15 | 12.7 | 18 | 0.1 | 2 | 0 | 0.3 |
| Example 3 | 60.1 | 3 | 0.6 | 0.15 | 11.5 | 20 | 0.3 | 2 | 0 | 0.5 |
| Example 4 | 60.1 | 3 | 0.8 | 0.125 | 13.9 | 16 | 0.3 | 2 | 0 | 0.1 |
| Example 5 | 60.1 | 3 | 0.4 | 0.125 | 12.7 | 18 | 0.5 | 2 | 0 | 0.5 |
| Example 6 | 60.1 | 3 | 0.6 | 0.1 | 11.5 | 20 | 0.5 | 2 | 0 | 0.3 |
| Example 7 | 60.1 | 3 | 0.6 | 0.1 | 9.5 | 20 | 0 | 4 | 0 | 0 |
| Example 8 | 60.1 | 3 | 0.6 | 0.1 | 8.5 | 20 | 0 | 5 | 0 | 0 |
| Example 9 | 60.1 | 3 | 0.6 | 0.1 | 7.5 | 20 | 0 | 6 | 0 | 0 |
| Example 10 | 60.1 | 3 | 0.6 | 0.125 | 9.9 | 16 | 0.3 | 6 | 0 | 0.3 |
| Example 11 | 60.1 | 3 | 0.4 | 0.1 | 8.7 | 18 | 0.3 | 6 | 0 | 0.5 |
| Example 12 | 60.1 | 3 | 0.8 | 0.1 | 7.5 | 20 | 0.5 | 6 | 0 | 0.1 |
| Example 13 | 60.1 | 3 | 0.4 | 0.15 | 9.9 | 16 | 0.5 | 6 | 0 | 0.3 |
| Example 14 | 60.1 | 3 | 0.6 | 0.15 | 8.7 | 18 | 0.1 | 6 | 0 | 0.1 |
| Example 15 | 60.1 | 3 | 0.8 | 0.125 | 7.5 | 20 | 0.1 | 6 | 0 | 0.5 |
| Example 16 | 60.1 | 3 | 0.8 | 0.15 | 5.9 | 16 | 0.5 | 10 | 0 | 0.5 |
| Example 17 | 60.1 | 3 | 0.6 | 0.125 | 4.7 | 18 | 0.5 | 10 | 0 | 0.1 |
| Example 18 | 60.1 | 3 | 0.4 | 0.125 | 3.5 | 20 | 0.1 | 10 | 0 | 0.3 |
| Example 19 | 60.1 | 3 | 0.6 | 0.1 | 5.9 | 16 | 0.1 | 10 | 0 | 0.5 |
| Example 20 | 60.1 | 3 | 0.8 | 0.1 | 4.7 | 18 | 0.3 | 10 | 0 | 0.3 |
| Example 21 | 60.1 | 3 | 0.4 | 0.15 | 3.5 | 20 | 0.3 | 10 | 0 | 0.1 |
| Example 22 | 60.1 | 3 | 0.6 | 0.1 | 8.5 | 20 | 0 | 0 | 5 | 0 |
| Example 23 | 60.1 | 3 | 0.6 | 0.1 | 7.5 | 20 | 0 | 0 | 6 | 0 |
| Comp. Ex. 2 | 60.1 | 3 | 0.6 | 0.1 | 3.7 | 18 | 0 | 11 | 0 | 0 |

As shown in FIG. 1, upon drying at 100° C., the drying shrinkage rate tends to decrease as the amount of glycerin is increased. In drying at 300° C., the drying shrinkage rate tends to decrease until the amount of glycerin reaches a certain value and increase when the amount of glycerin is increased more than the certain value. By forming an outer wall of a honeycomb structure using a coating material containing 2 to 10% of glycerin, crack generation in the outer wall can be reduced or prohibited (Examples 1 to 23). In the case that glycerin was not added to the coating material (Comparative Example 1) and the case that 11% of glycerin was added to the coating material (Comparative Example 2), a crack was generated. There is a correlation between the drying shrinkage rate and the crack generation, and the shrinkage rate should be 0.85% or less in order to prohibit crack generation.

In the case that 4 to 10% of glycerin is added to the coating material, water evaporates in drying at 100° C., and glycerin evaporates in drying at 300° C. Therefore, since drying shrinkage is caused by being dispersed at each temperature, it can be considered that a crack is hardly generated because shrinkage is not caused rapidly. In contrast, in the case that no glycerin is added to the coating material, a crack is generated by rapid shrinkage in drying at 100° C. In the case that 11% or more of glycerin is added to the coating material, it is considered that a crack is easily generated because rapid shrinkage is easily caused in drying at 300° C. Also, in the case that dipropylene glycol is added to the coating material, it was confirmed that there is an effect in inhibiting crack generation similarly.

The present invention can suitably be used as a method for manufacturing a ceramic honeycomb structure used as a filter, a catalyst carrier, or the like.

What is claimed is:

1. A method for manufacturing a ceramic honeycomb structure, the method comprising the steps of:
preparing a coating material containing at least a ceramic powder, water, and a high-boiling additive having a higher boiling point than that of water;
applying the coating material on another periphery of a cell structure having a plurality of cells separated by ceramic porous partition walls as to cover the outer periphery; and
drying the coating material by heating to form an outer wall.

2. The method for manufacturing a ceramic honeycomb structure according to claim 1, wherein a first drying is performed in a temperature range from the boiling point of water to the boiling point of the high-boiling additive, followed by a second drying performed at a temperature of the boiling point of the high-boiling additive or higher.

3. The method for manufacturing a ceramic honeycomb structure according to claim 1, wherein the high-boiling additive is a water-soluble substance.

4. The method for manufacturing a ceramic honeycomb structure according to claim 2, wherein the high-boiling additive is a water-soluble substance.

5. The method for manufacturing a ceramic honeycomb structure according to claim 1, where in the high-boiling additive is at least one kind selected from the group consisting of glycerin, propylene glycol, dipropylene glycol, butylene glycol, diethylene glycol, polyethylene glycol, and 1,5-pentanediol.

6. The method for manufacturing a ceramic honeycomb structure according to claim 1, wherein the high-boiling additive is at least one kind selected from the group consisting of glycerin, propylene glycol, dipropylene glycol, butylene glycol, diethylene glycol, polyethylene glycol, and 1,5-pentanediol.

7. The method for manufacturing a ceramic honeycomb structure according to claim 3, where in the high-boiling additive is at least one kind selected from the group consisting of glycerin, propylene glycol, dipropylene glycol, butylene glycol, diethylene glycol, polyethylene glycol, and 1,5-pentanediol.

8. The method for manufacturing a ceramic honeycomb structure according to claim 4, wherein the high-boiling additive is at least one kind selected from the group consisting of glycerin, propylene glycol, dipropylene glycol, butylene glycol, diethylene glycol, polyethylene glycol, and 1,5-pentanediol.

9. The method for manufacturing a ceramic honeycomb structure according to claim 1, wherein the coating material contains 2 to 10% glycerin as the high-boiling additive.

10. The method for manufacturing a ceramic honeycomb structure according to claim 1, wherein the coating material contains 2 to 6% dipropylene glycol as the high-boiling additive.

11. The method for manufacturing a ceramic honeycomb structure according to claim 9, wherein, after the coating material is applied, the first drying is performed at a temperature range from 100 to 200° C., followed by the second drying performed in a temperature range from 300 to 400° C.

12. The method for manufacturing a ceramic honeycomb structure according to claim 10, wherein, after the coating material is applied, the first drying is performed at a temperature range from 100 to 200° C., followed by the second drying performed in a temperature range from 300 to 400° C.

13. A coating material used for a method for manufacturing a ceramic honeycomb structure according to claim 1 and containing at least a ceramic powder, water, and a high-boiling additive having a higher boiling point than that of water.
